(19) United States
(12) Patent Application Publication
(10) Pub. No.: US 2010/0011073 A1
(43) Pub. Date: Jan. 14, 2010

(54) USER-DEPLOYABLE DATA TRANSFORMATION AND EXCHANGE PLATFORM INCLUDING ON-DEMAND ITEM SYNCHRONIZATION AND USER-DEPLOYABLE ORDER MANAGEMENT SYSTEM

(75) Inventors: John N. Kachaylo, Moon Twp, PA (US); J. Russel White, Pittsburgh, PA (US); Tim J. Megahan, Valencia, PA (US); Lugina Dickson, Sewickley, PA (US); Bradley M. Bridgham, Gibsonia, PA (US); George W. McKee,, III, Pittsburgh, PA (US)

Correspondence Address: BLYNN L. SHIDELER;THE BLK LAW GROUP, 3500 BROKKTREE ROAD, SUITE 200, WEXFORD, PA, 15090, US

(73) Assignee: TRUE COMMERCE, INC., Wexford, PA (US)

(21) Appl. No.: 12/482,193

(22) Filed: Jun. 10, 2009

Related U.S. Application Data
(60) Provisional application No. 61/060,435, filed on Jun. 10, 2008.

(51) Int. Cl. G06F 15/16

(52) U.S. Cl. 709/206; 709/246; 719/328

(57) ABSTRACT

A user-deployable data transformation and exchange platform includes on demand item synchronization formed by a user buildable dynamic link library associating incongruent article identifiers to reference common articles; and a user deployable order management system for generating, sending, receiving, and tracking the status of documents, such as purchase orders and invoices, facilitating commerce between the user and at least one other party. The platform may include an on-line network exchange. The system may include member originated, participant invitation for new member registration, including electronic notification to prospective members, and wherein new member registration utilizes data generated by the member originating the invitation. Searchable transaction histories may be maintained for member users, with each transaction having a current status identified and the ability to be flagged by a member user.

### RELATED APPLICATIONS

This application claims the benefit of provisional patent application Ser. No. 61/060,435 filed Jun. 10, 2008 entitled “User-Deployable Data Transformation and Exchange Platform”.

### BACKGROUND OF THE INVENTION

1. Field of the Invention

The present invention relates to an order management system and a data exchange platform, and more particularly to a user deployable data transformation and exchange platform and a buyer side user deployable order management system.

2. Background Information

A myriad of protocols exist for establishing a computer-to-computer exchange of data but Electronic Data Interchange (EDI), which is regulated by the American National Standards Institute (ANSI), is well established as the leading standard for business-to-business e-commerce, supporting more than a third of the US GDP. Adoption of EDI is driven primarily through very large organizations, and for all practical purposes remains a niche solution with less than 1% of the approximately 26 million US-based small to mid-tier businesses (fewer than 1,000 employees) using EDI.

Research indicates that these smaller businesses would benefit greatly from the efficiency and accuracy derived from using EDI to automate the computer-to-computer exchange of business data, but it is not practical for them to deploy an EDI solution due to the associated complexity and cost. As an example, a common burden faced by these businesses is the process of manually entering data associated with transaction-related documents, such as orders and invoices, into their computer-based business applications. It is estimated that due to the inherent risk of making mistakes while manually keying data, 20% of orders are filled imperfectly and 60% of invoices contain errors.

The present invention addresses some of the needs shown in the prior art.

### SUMMARY OF THE INVENTION

Some of the advantages of the present invention are achieved with a user-deployable data transformation and exchange platform using a combination of software, systems and methods to automate the transfer of information between two or more computer-based applications. Specifically one aspect of the invention provides a user-deployable data transformation and exchange platform that includes on-demand item synchronization formed by a user-buildable dynamic link library associating incongruent article identifiers used by the user and at least one other party to reference a common article to be purchased or sold between the user and the party; and a user-deployable order management system for generating, sending, receiving, and tracking the status within defined workflows of documents necessary to facilitate the procurement of goods and services between the user and at least one other party.

The user-deployable data transformation and exchange platform according the present invention may further include data normalization software, data conversion software and data mapping software and a common network exchange coupling the user with each other party. The data normalization software, data conversion software and data mapping software and the common network exchange may be provided on-line.

One aspect of the present invention provides a user-deployable order management system for generating, sending, receiving, and tracking the status within defined workflows of documents necessary to facilitate the procurement of goods and services between a member user and at least one other member or non-member party, and including automated, member user originated, participant invitation for registration of new members.

The user deployable order management system according to one aspect of the present invention may provide that the automated, member user originated, participant invitation includes e-mail notification to a prospective member and wherein the registration of new members utilizes at least some data associated with the new member that was generated by the member generating the participant invitation.

The user-deployable order management system according to one aspect of the present invention is a buyer-side management system. The user-deployable order management system according to one aspect of the present invention provides that the documents tracked include at least purchase orders and invoices.

The user-deployable order management system according to one aspect of the invention includes searchable transaction histories are maintained for member users, with each transaction having a current status identified and the ability to be flagged by a member user within the system.

One key distinction of the present invention from systems of the prior art is the “User-deployable” aspect of the present system which is the ability for users with only basic PC and software aptitude to quickly and easily set up, use and maintain the functionality provided without third-party assistance. Thus, within the meaning of this patent application the term “user-deployable” references functionality that allows the user to acquire, install, configure, use and maintain an application without the assistance of a third party or additional resources. The benefits of this solution are analogous to enabling individuals to automate the completion of their tax returns without the involvement of accountants or tax professionals.

Another key aspect, which is a subset of the user-deployable feature, is the “user driven expansion” of the membership in the system using the automated, member user originated, participant invitation for registration of new members. An important aspect for making the user driven expansion meaningful is substantially frictionless recipient or new member adoption of the system, such as through the population of new member data fields at registration with a fair amount of new member information obtained by the invitation originating member user.

A practical application of the present invention is the use of the present system use as a conduit for two or more companies to exchange business information (such as catalog item details, orders, invoices or payment remittance advice) between their respective business management applications (such as accounting or inventory management software) with little or no human interaction.

Within the meaning of this patent application the phrase “data transformation” references converting the structure of digital information so that it can be shared between dissimilar computer systems while maintaining content integrity of the digital information.

Within the meaning of this patent application the phrase “exchange platform” references protocol that facilitates the secure and expedient transfer of data between computer-based systems.

Within the meaning of this patent application the phrase “order management system” defines a set of algorithms that automate the processes associated with generating, sending, receiving, and tracking the status within defined workflows of documents necessary to facilitate the procurement of goods and services.

Within the meaning of this patent application the term “on-demand” defines a system that performs a requested functionality only when required as part of defined workflow, and may also be referenced as “on the fly”.

Within the meaning of this patent application the phrase “item synchronization” defines the associating of incongruent identifiers used by two or more parties to reference a common article of the parties, such as articles to be purchased or sold between the parties.

These and other advantages of the present invention will be clarified in the description of the preferred embodiments taken together with the attached drawings in which like reference numerals represent like elements throughout.

### BRIEF DESCRIPTION OF THE DRAWINGS

The invention is illustrated by way of example, and not by way of limitation in the figures of the accompanying drawings in which like reference numerals refer to similar elements.

FIG. 1 is a detailed block diagram of an exchange system constructed according to one aspect of the present invention.

FIG. 2 is a detailed block diagram of the deployment method constructed according to one aspect of the present invention.

FIG. 3 is a schematic flow chart illustrating the flow or orders and invoices using the order management system of the present invention.

FIG. 4 is a schematic flow chart illustrating a registration process for a new seller on the order management system according to one aspect of the present invention.

FIG. 5 is a schematic flow chart illustrating a purchase order importing process for a new vendor on the order management system according to one aspect of the present invention.

FIG. 6 is a schematic flow chart illustrating a purchase order importing process for an existing system vendor on the order management system according to one aspect of the present invention.

FIG. 7 is a schematic flow chart illustrating an invoice exporting process on the order management system according to one aspect of the present invention.

FIG. 8 is a listing of the status identifiers for the order documents on the order management system according to one aspect of the present invention.

FIG. 9 is a listing of the status identifiers for the invoice documents on the order management system according to one aspect of the present invention.

FIG. 10 is a schematic flow chart illustrating a process when a sellers receives a new order on the order management system according to one aspect of the present invention.

FIG. 11 is a schematic flow chart illustrating an order generating process on the order management system according to one aspect of the present invention.

FIG. 12 is a schematic flow chart illustrating an transaction turnaround process on the order management system according to one aspect of the present invention

FIG. 13 is a schematic flow chart illustrating a representative order and invoice process on the order management system according to one aspect of the present invention.

FIG. 14 is a schematic flow chart illustrating a seller's process on the order management system according to one aspect of the present invention.

FIG. 15 is a schematic flow chart illustrating a buyer's process on the order management system according to one aspect of the present invention.

FIG. 16 is a representative screenshot illustrating a send orders screen of a new user on the order management system according to one aspect of the present invention.

FIG. 17 is a representative screenshot illustrating an adding vendor screen of a user on the order management system according to one aspect of the present invention.

FIG. 18 is a representative screenshot illustrating send orders search or filter screen of a user on the order management system according to one aspect of the present invention.

FIG. 19 is a representative screenshot illustrating a selected order detail screen of a user on the order management system according to one aspect of the present invention.

FIG. 20 is a representative screenshot illustrating an orders sent screen of a user on the order management system according to one aspect of the present invention.

FIG. 21 is a representative screenshot illustrating a selected order detail screen of a user on the order management system according to one aspect of the present invention.

FIG. 22 is a representative screenshot illustrating a selected invoices received screen of a user on the order management system according to one aspect of the present invention.

FIG. 23 is a representative screenshot illustrating a selected invoices received screen of a user on the order management system according to one aspect of the present invention.

FIG. 24 is a representative screenshot illustrating an e-mail invitation for a new vender on the order management system according to one aspect of the present invention.

FIG. 25 is a representative screenshot illustrating an invoice listing for a vender on the order management system according to one aspect of the present invention.

FIG. 26 is a representative screenshot illustrating an invoice detail view for a vender on the order management system according to one aspect of the present invention.

### DESCRIPTION OF THE PREFERRED EMBODIMENTS

A true peer-to-peer platform that enables small to mid-tier businesses of any size or level of technical sophistication to easily initiate, use and maintain an electronic data exchange for sharing business information in a fully automated and integrated manner without the assistance of third-party expertise does not previously exist. Previously commercial options for electronically connecting two or more instances of computer-based business applications require human interaction by individuals or organizations possessing a high degree of specialized software proficiency.

This invention is distinguished by its ability to overcome the limitations found in the prior art. It does so by automating actions that require technical proficiency, standardizing the way incongruent data is shared, and by applying a software user interface that emulates human interaction throughout a process flow that replicates the delivery of expert guidance.

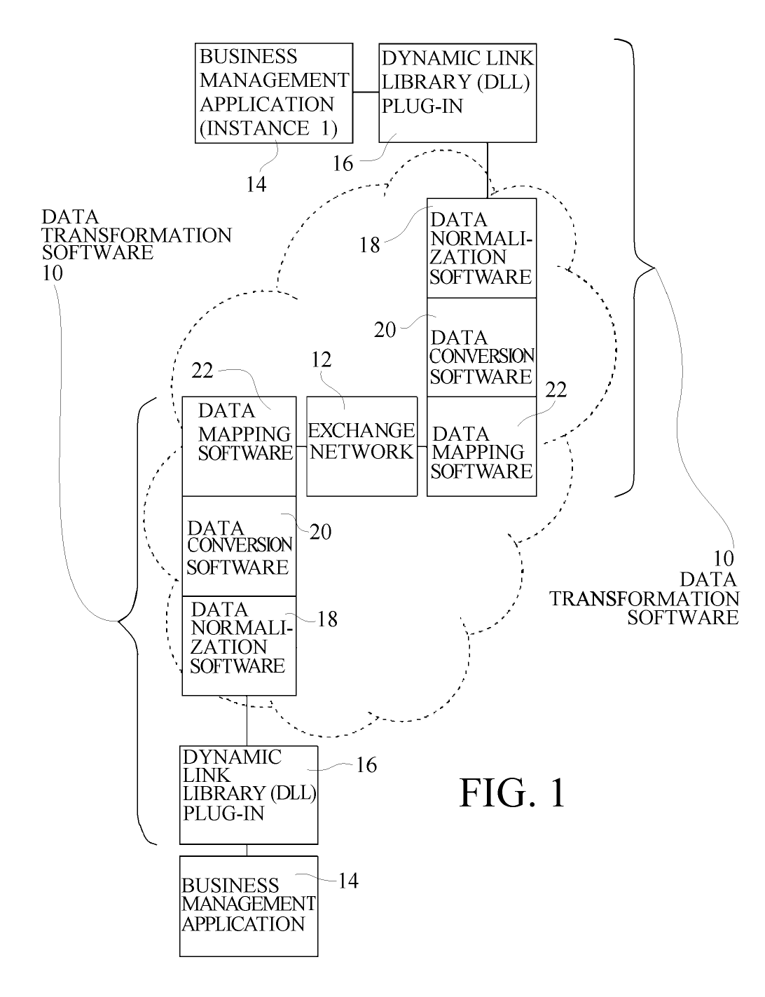

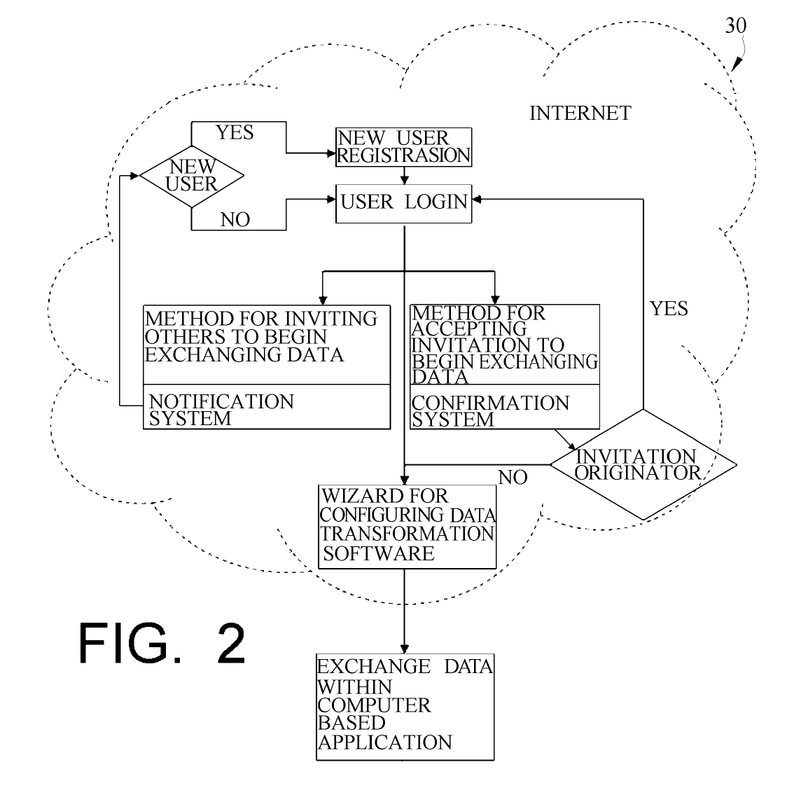

The present invention in one embodiment reflected in FIGS. 1-2 is comprised of data transformation software, collectively 10, an Internet-based exchange network 12 and a set of systems and methods, all of which are applied to existing data exchange standards (i.e., ANSI X12 EDI, EDIFACT, or XML) to enable the computer-to-computer exchange of data. The data that is imported or exported from the business system 14 is limited to the data that the business system supports.

The data transformation software 10 extracts data from and imports it to the respective computer-based business applications 14, such as Peachtree® or the like, using a dynamic link library (DLL) plug-in 16, normalizes, at element 18, incongruent data using a token-based nomenclature, converts, at element 20, data to and from the standard being applied (e.g. EDI) and the format recognized by each respective business application 14, and maps, at element 22 data elements to comply with the unique data model of each respective business application 14.

The dynamic link library 16 is unique to the individuals and built by the member users as needed. With an initial order, the member user of the present invention is prompted to develop or add to the link library, making it a dynamic link library 16. Future orders between the same member parties will often utilize the same small subset of items in the link library 16. If a future order or product designation changes, the system prompts the member user for a revised update to the dynamic link library 16. This aspect of the present invention is referenced as on-demand or on the fly item synchronization. The dynamic link library 16 is intended to be a user built system specific to each application 14 to application 14 transfers.

Many prior data transformation and exchange system attempt to create a universe of all possible data exchanges between any set of members prior to system implementation. It has been found that in any given data exchange between given partners only a small fraction of the possible data items are utilized. As an example if a store owner periodically orders a selected set of candles for sale in their store from a given vendor, each purchase order will likely reflect only a small fraction of the items in both parties' business applications 14.

The dynamic link library portion 16 of the entire data transformation software is thus unique to the user and generally implemented on the user's computer system, as schematically represented in FIG. 1. The remaining modules 18, 20 and 22 of the software 10 are common and can efficiently be housed on the exchange network 12. Alternatively, each user could have the entire software 10 onsite, or (as another alternative) individual unique dynamic link libraries 16 could be stored on-line and be selectively accessed, but the schematic representation of FIG. 1 is believed to be the most efficient implementation of the user-deployable data transformation and exchange platform according to one aspect of the present invention.

The exchange network 12 provides a hosted service offering that leverages the Internet to act as the conduit between each respective computer-based business application 14. The present invention delivers a unique set of systems and methods for acquiring and registering new users such as broadly set forth in the flow chart 30 of FIG. 2, and enabling them to configure, learn to use and maintain their respective instance of the solution without external assistance.

Another aspect of the present invention that can, but need not, include exchanging data between applications 14, is use of the present invention as an order management system, which as defined above is a process or system associated with generating, sending, receiving, and tracking the status within defined workflows of documents, such as purchase orders and invoices, necessary to facilitate the procurement of goods and services. It should be understood in the following description that the order management system can also include the data transformation and exchange aspects discussed above, which will fully integrate the buyer and sellers business applications 14, however the order management aspects of the present invention are also very useful independently, without this compete integration. In other words the users will find great utility in the system as solely an order management system, even if sellers need to manually enter data into their own application 14. The present invention is being prepared and marketed by the assignee of this application under the CONEKTU™ brand, as described hereinafter.

Some objectives of the order management system of the invention will be for buyers to easily send orders to vendors; for buyers to easily receive order confirmations from vendors; and for easy integration by the buyers of purchase orders and invoices into business applications, such as QUICKBOOKS® and PEACHTREE® applications; for “registered” sellers to easily receive orders from customers, easily create invoices from inbound orders, easily send invoices to customers, easily receive invoice confirmations from customers, and even allow for listing in Conektu™ seller marketplace. In the present invention non-registered sellers are not excluded from receiving orders within the system, but will only receive orders and will not be able to track documents or generate invoices within the system.

As will be apparent from the following description, the profile for users of the order management system of the present invention will consist of both buyers and sellers. The buyers are be the target market and will drive adoption for the sellers. It is possible that a user will act as both a buyer and a seller. Regardless, this system can be categorized as a buyer-side order management solution. Consequently, buyers will also be referenced as members, users and member users in the present application. Sellers can be referenced as vendors, and can be separated into registered and non-registered sellers or venders. In certain contexts the registered sellers can also be referenced as members, users or member users.

Although applicable for a wide variety of users, the present order management system is particularly well suited for use with small to medium sized businesses, such as one man shops or family owned businesses with no outside employees, and those that purchase wide variety of SKUs, and that place large number of orders, and that have a heavy reliance on drop shippers, and in which delivery of orders is time sensitive.

There will be two types of sellers using present invention as an order management system, namely registered and non-registered. The registered sellers will have one or more of their customers using the present invention as at least an order management system and they will receive orders from one or many of their customers via the order management system of the present invention. Non-registered sellers can receive orders within the system so as not to restrict the application of the system to the users, however they will not be able to generate invoices or track such invoices in the system. As described in greater detail below, sellers who register, i.e. those whom create an account with Conektu™ exchange 12, will have access to the following functionality: Email or other designated notifications when new orders are received; view orders received; turn orders into invoices to send them back to their customers; and receive invoice confirmation; and, as an option, have a listing in the Conektu™ exchange listing to advertise their products or services.

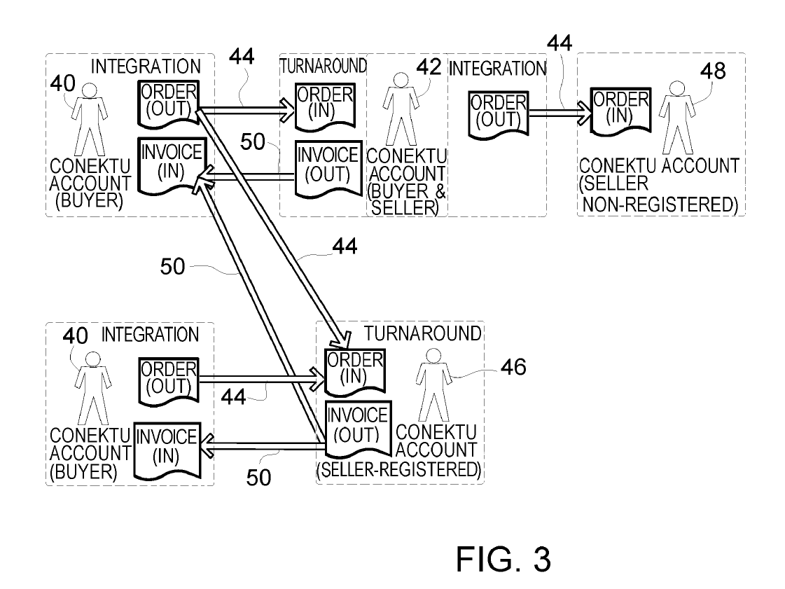

The arrangement is schematically illustrated in FIG. 3 in which the present order management system is used by a plurality of buyers 40, including a buyer and seller 42, which use the system to send orders 44, pulled from the buyers business application 14, through exchange 12 to registered vender 42 (buyer and seller); registered vender 46, and to unregistered vender 48. The registered venders can use the system to create and return and track an invoice 50 through exchange 12, which can be incorporated into the buyer's application 14.

As this is generally a buyer's side solution, users that act as buyers (40 and 42 above) will need to complete an installation on their machine for support of the integration into their business system 14. Members acting as only sellers 40 will not need to complete an installation for use of the order management aspects of the present invention, as all of their interaction with the present system will be via the web or exchange 12. This minimal seller implementation aspect allows for easy user-driven expansion of the system as described below, and the expansion model of the system can be referenced as a user-driven, viral expansion model providing for substantially frictionless recipient adoption.

As in other software as a service business models, upgrades to the website or exchange 12 will need to take place with little to no interruption of service to users. As the product is largely web based, updates will be deployed to all users at once. Thus upgrades to Conektu™ business system integrations will need to be as seamless as possible for the user. The website or exchange 12 will be expected to be supported on several conventional operating systems such as, but not limited to, Windows®, Mac® and Linux® operating systems. Further, conventional browsers should be supported, such as Internet Explorer®, Firefox®, Chrome® and Safari® browsers.

A user's account on the system will integrate with whichever company a user has open while they are processing transactions in the system. As a result, the present invention will inherently support a multiple company per business system scenario. As described herein a user's account can act as a buyer or customer 40, vendor 46 or both 42. Further in an account a user can interact with other customers, vendors or both. Multiple user logins will be supported for each user account. Username may be the user's email address. The initial user of a company (which will establish an account for their company) will be able to choose their password during registration. Users that are invited to an existing account by existing users will receive a temporary password and be prompted to enter their preferred password upon their first successful login.

The system will include “forgot my password” link which is available on a login page. Users can choose to “remember me” which will save their login and password. Further, the company name and email (login) will appear in the top right once the user is logged in.

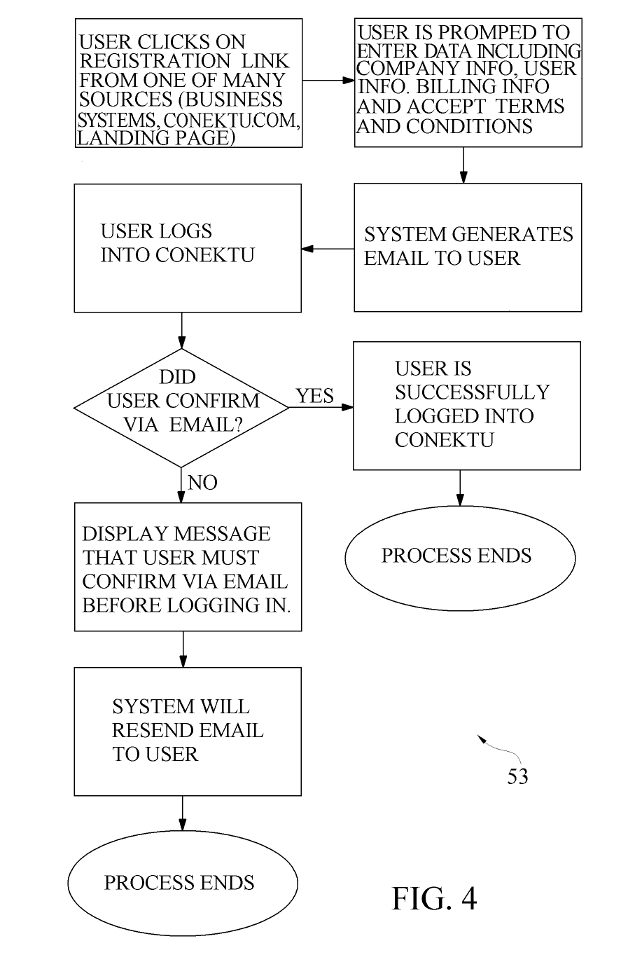

One important aspect of growing the system for maximum benefit to all the users is that existing users in the system can simply invite other users to the system. This aspect of the invention may also be referenced as a self-selling or user-driven expansion aspect of the system. The user that was added will receive an email from the system with their login (email address) and their temporary password. The user must confirm their email address, such as via the email, prior to logging into the system. The first time that the user logs into the system, they will enter their temporary password. Upon login, the initial user will be prompted to enter a password as well as a security question. The general operation is reflected in the flow chart 53 of FIG. 4.

The present invention contemplates the inclusion of roles and permissions for various levels of user's, such as Administrator, Vendor and Customer, and the vendor or customer accounts can have varied roles and permissions for user's under those accounts as well.

The registration of a new buyer 40 (or seller/buyer 42) is more detailed than the registration of a seller only 46 on the system. The buyer, when he first (as a buyer) logs into the account, the (first time buyer) user will be prompted to complete the buyer configuration wizard.

Following are the steps for the Buyer wizard. First the user specifies their business system 14 which may be in the form of a drop down that includes supported systems, such as QuickBooks® (specify each type), or Peachtree® (specify each type). It is mandatory that the user enter this data for the system to pull the order documents from, and to place invoice information into if dealing with registered sellers. The buyer wizard will allow for the user to invite other users (i.e. vendors) to the account where the user can add other users to the account, with the user entering in the appropriate email address or addresses. The new user can optionally upload an image or logo to appear on their orders.

Contrasting the buyer registration with the seller registration, the seller registration is a simpler process. The seller, at registration, would generally specify the contents of the system listing. Possible data to be part of the listing include, but are not limited to, business or product classification, website link and address, short descriptions of product or business and contact information. As with the buyers, the sellers at registration will be invited to add other users to the account to expand the universe of registered users, wherein the user types in the appropriate email address. The sellers at registration can upload an image or logo to appear on their documents.

To further simplify the registration of either the buyer or the seller which have been invited to the system, many of the required data fields will be filled in from information supplied by the member that generated the invitation. Consequently, a new seller that is not adding to the product, business or contact information that the member generating the invitation has supplied may join with little more than a single click and designating a new password.

The system will allow buyers 40 and 42 to deal with unregistered sellers 48 (i.e. those that chose to remain unregistered). The non-registered sellers 48 may be restricted from logging onto the online exchange 12 of the present invention other than to view the order and may only receive Orders 44 via email (with a link to facilitate registration, if desired) or other designated manner (essentially the manner they are conducting business at the moment).

The basic order management only component of the present invention will support the following order management document types in its simplest form: orders sent 44; invoices sent 50; orders received 44; and invoices received 50. The data comprising inbound and outbound orders 44 is essentially the same. Orders 44 are sent to vendors/sellers 42, 46 and 48 and orders 44 are received from customers/vendors 40 or 42. The data comprising inbound and outbound invoices 50 is essentially the same. Invoices 50 are sent to buyers/customers 40 or 42. Invoices 50 are received from only registered vendors 46 or 42. Thus the data fields contained for the outbound order 44 and the inbound order 44 will be very similar, and the data fields contained in the outbound invoice 50 and the inbound invoice 50 will be very similar.

It is anticipated that the system of the present invention can be implemented as only an order management system without adding the data transformation and exchange aspects of the present invention described above in connection with FIG. 1. In such implementation, referenced as “only buy side integration”, the order 44 is imported into the system of the invention from business system application 14 of the buyer 40 or 42 and the invoice 50 is exported from the system into business system application 14 of the buyer 40 or 42.

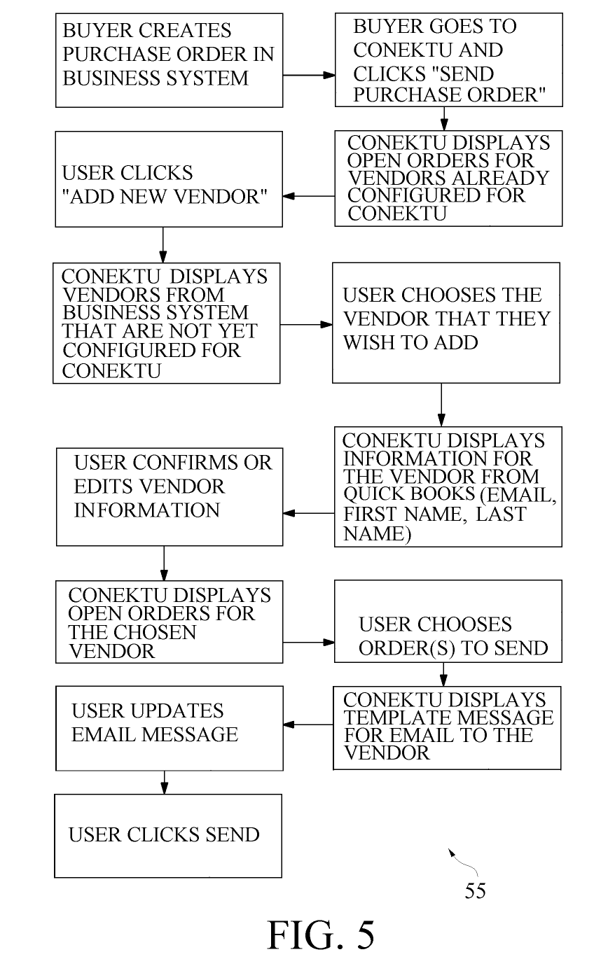

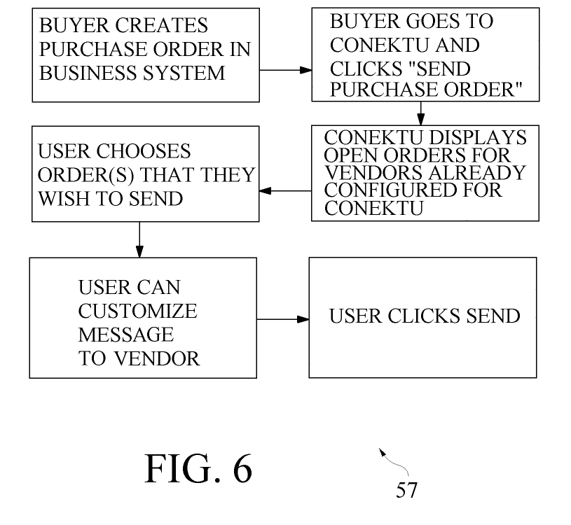

The following is a description of importing a purchase order 44 into the present system. Validation will be completed on the vendor name, wherein the only purchase orders 44 that will be available in system will be those that belong to a vendor that exists in business system 12 and which is known to the system. This supported vendor can be a system registered vendor 46 or 42 or unregistered vendor 48. FIG. 5 details the steps in flow chart 55 in the process for importing purchase orders 44 into the system for a new vendor and, in contrast, FIG. 6 details the steps in the process for importing purchase orders 44 into the system for an existing vendor 42, 46 or 48.

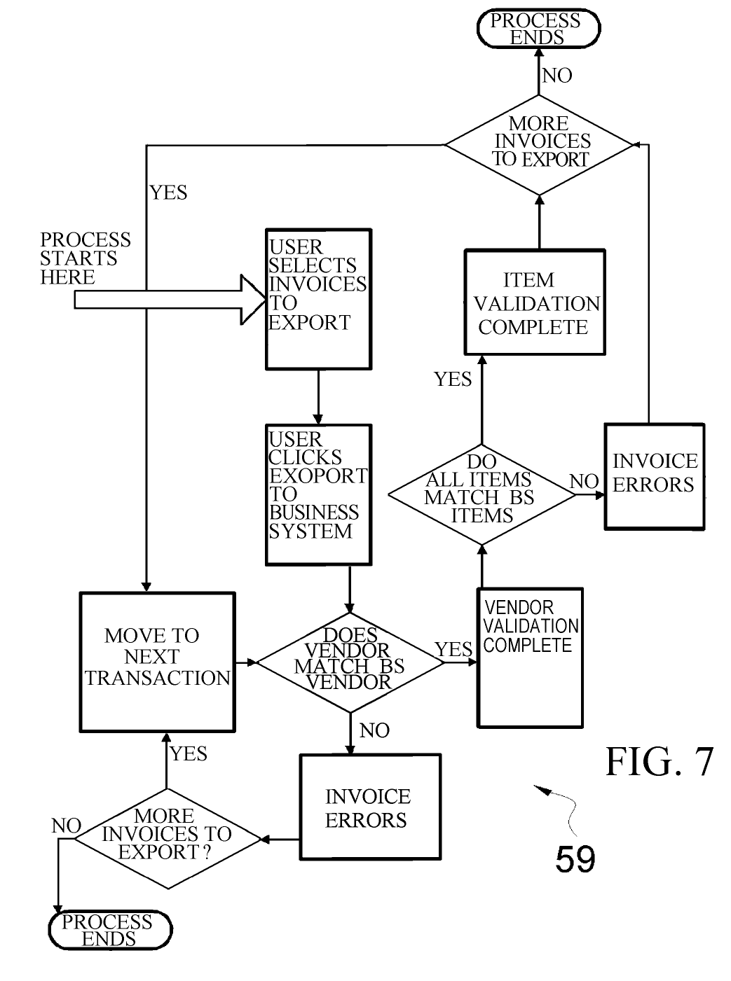

The following is a description of exporting an invoice 50 from the present system into the buyers system or application 14. The invoice 44 will be imported into the business system 14 as a bill. The SDK or devkit may also kick off other process such as closing out the purchase order, etc. This will be dictated by the SDK and may change from business system 14 to business system 14. Validation of the invoice 50 will be dictated by the requirements of the buyer's application 14. Validation of vendor name, Item listing and GL Accounts would be expected. It should be a very rare instance for an invoice 50 to fail either vendor or item validation. This is because the vendors or items on the invoices should be originated from the purchase order that came from the buyer's application 14 in this order management system. FIG. 7 details the steps, in flowchart 59, the process for exporting invoices 50 from the system to the business system or application 14.

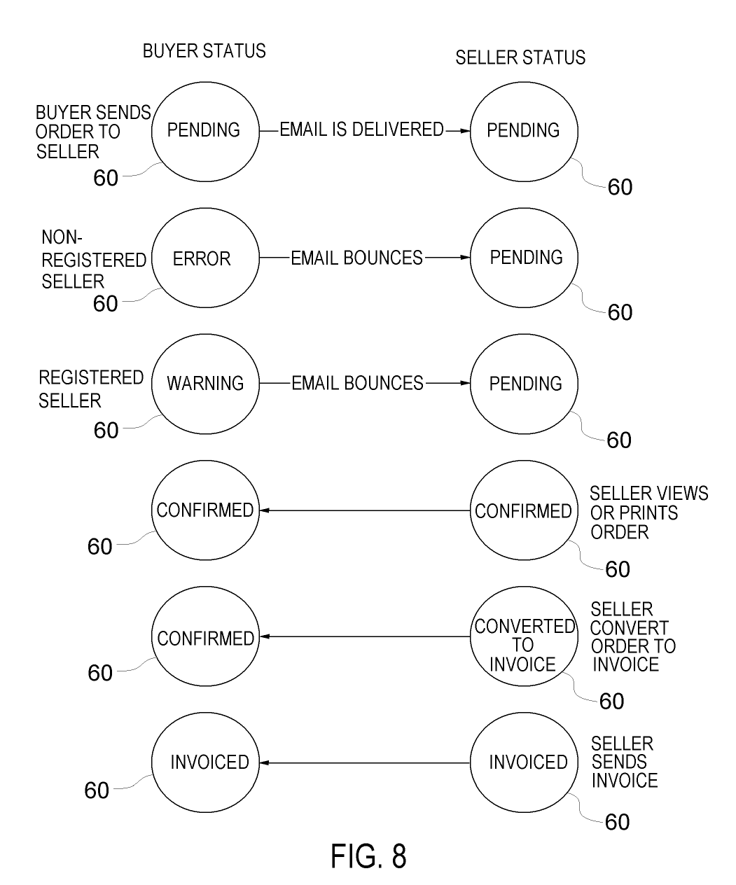

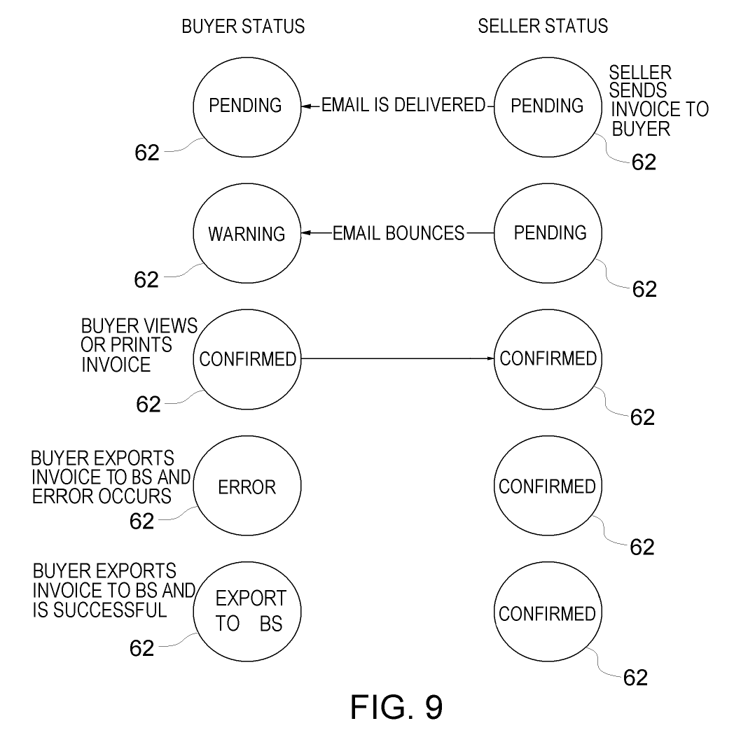

Documents will be designated with various status states or identifiers throughout their lifecycle in the present order management system. The status will vary based on whether a given user is viewing the document as a seller or buyer. The status identifiers include: (a) pending—an outbound document (purchase order or invoice) that was sent to either a customer or vendor or an inbound document that has not yet been confirmed; (b) confirmed—in outbound document or inbound document that was “confirmed” (viewed, printed, exported, converted to invoice) by the receiver; (c) error—either an inbound document or an outbound document that is in an error state (reasons for errors include where an order is exported from the business system and an error occurs; an invoice is imported into the business system and an error occurs, and an order or invoice is sent and the email bounces back.); (d) invoiced—an order that has been invoiced (e.g. seller view—the seller has completed the turnaround and sent the invoice to the customer and buyer view—the buyer has received the invoice from the seller for the order.); (e) converted to invoice—a seller converted an order to an invoice, but the invoice has not been sent; and (f) exported to the business application—a buyer has exported the invoice to their business system or application 14. The status identifiers 60 of the orders 44 are shown in FIG. 8 and the status identifiers 62 of the invoices 50 are shown in FIG. 9.

Any time that a user sends an order document via the present system as an order management system (e.g., orders 44 or invoices 50) the transaction is first in a pending status for the sender, and an email notification is generated to the recipient to notify them that a document is available (more than one designated e-mail may be utilized, as appropriate or as designated), and the transaction is available on-line at exchange 12 for the recipient in a pending status, further the user can add a personalized message to accompany the email.

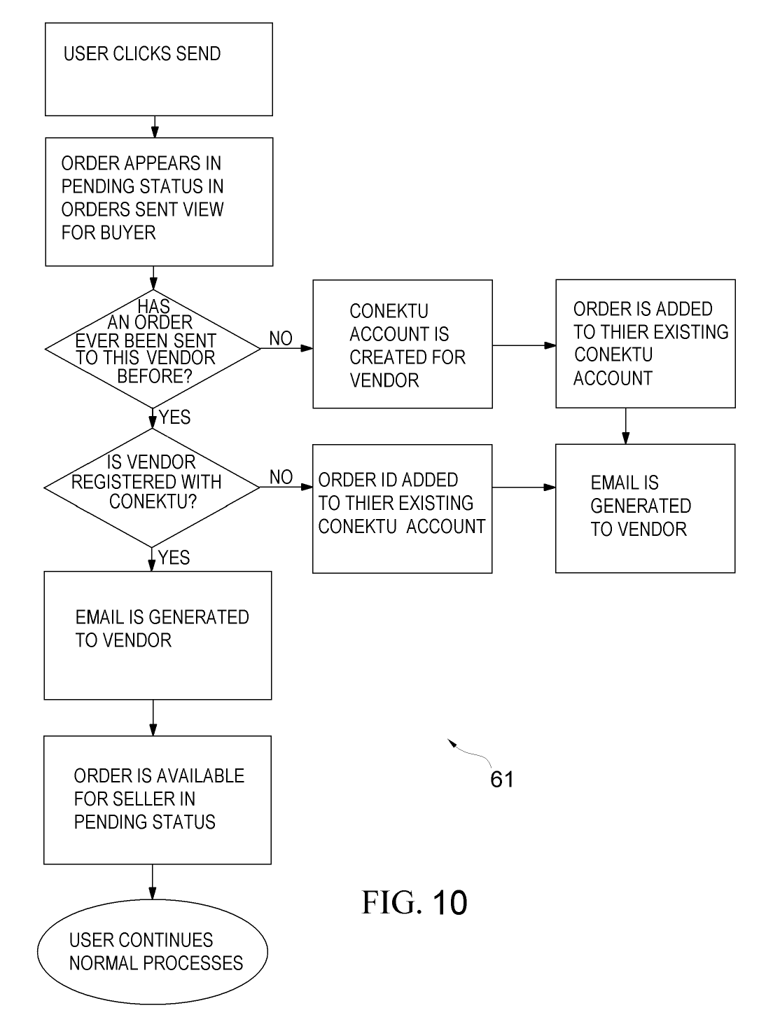

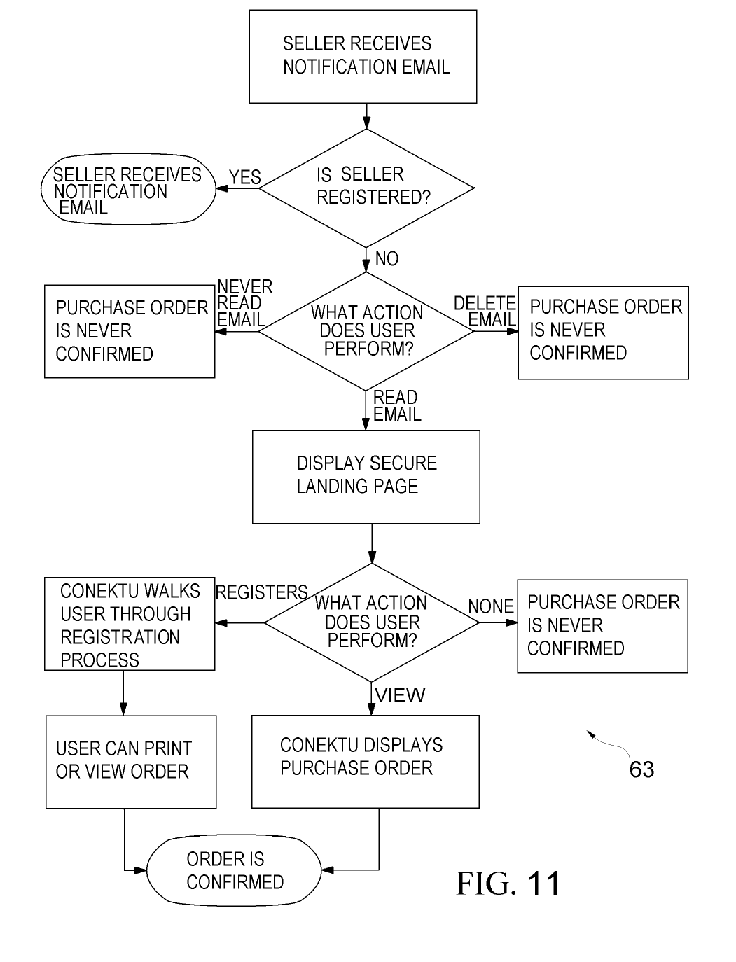

The system aspects, shown in flowchart 61 of FIG. 10, of the process for sending orders 44 is that (a) accounts will automatically be generated for new vendors, which will allow the system to display their information, and if they decide to register at a later time, their data is available for them; (b) if a seller does not register, their transaction history will continue to accumulate in their “account” which is effectively then an internal system file. Email addresses can be used by the system as a unique identifier to understanding if a seller is registered with the system. For example, if a buyer 40 or 42 sends an order 44 to their vendor 42 or 46 for the first time it is possible that the vendor 42 or 46 is already registered with the present system. The system will know this because email address is a unique identifier. In this case, the order 44 should be sent to the registered seller 42 or 46 as normal (email is generated and it appears in orders received view.). The process of a seller receiving a new order is described in flow chart 63 of FIG. 11. When the registered buyer receives a new invoice he will receive a notification e-mail. When the seller views an order the buyer will receive an email notification.

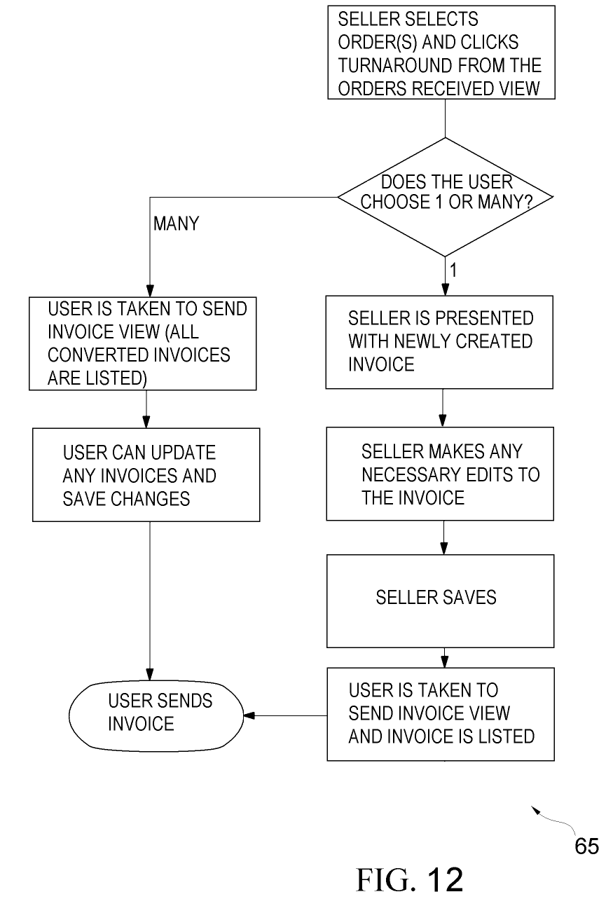

The next aspect of the order management system of the invention is to describe the “transaction turnaround” of converting an order 44 into an invoice 50 for registered sellers 42 or 46. Only registered sellers 42 or 46 can complete a transaction turnaround on orders 44 to create invoices 50. The turnaround will take all appropriate data that is on the order 44 and populate it in the invoice 50. The invoice 50 remains in the “buyer's format”. Even if the system is expanded to operate as a data transformation and exchange platform as discussed above in connection with FIGS. 1-2 so as to be integrated into both the buyers and sellers business systems 14, the order management aspects of the present invention are operating as essentially a buyer's side solution. Thus the invoice 50 of the order management system will be populated essentially directly with information from the order 44. Sellers will have the ability to make updates to the invoice before sending. The invoice number will be auto-generated but can be over-ridden. The process for transaction turnaround is described in the process flowchart 65 of FIG. 12.

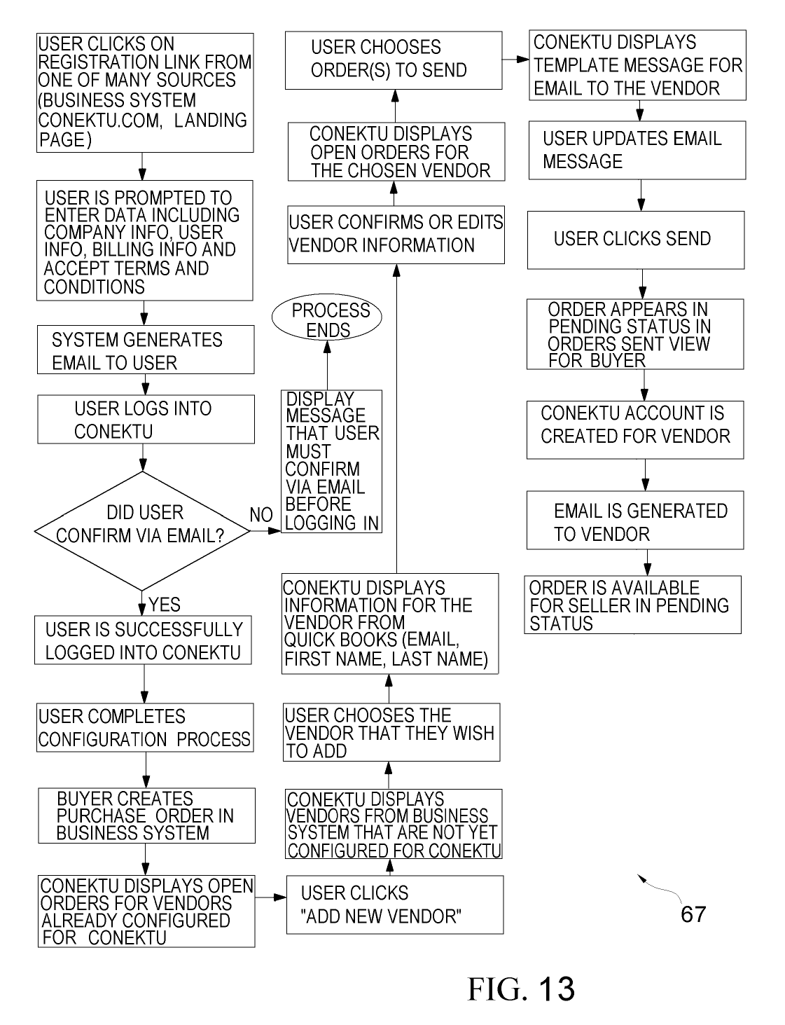

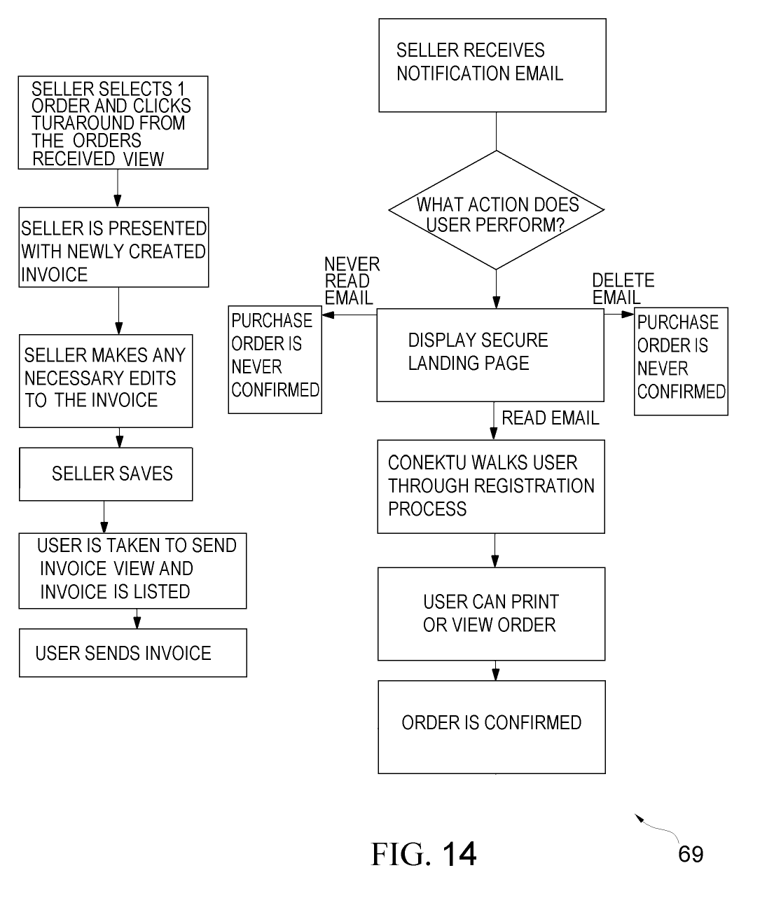

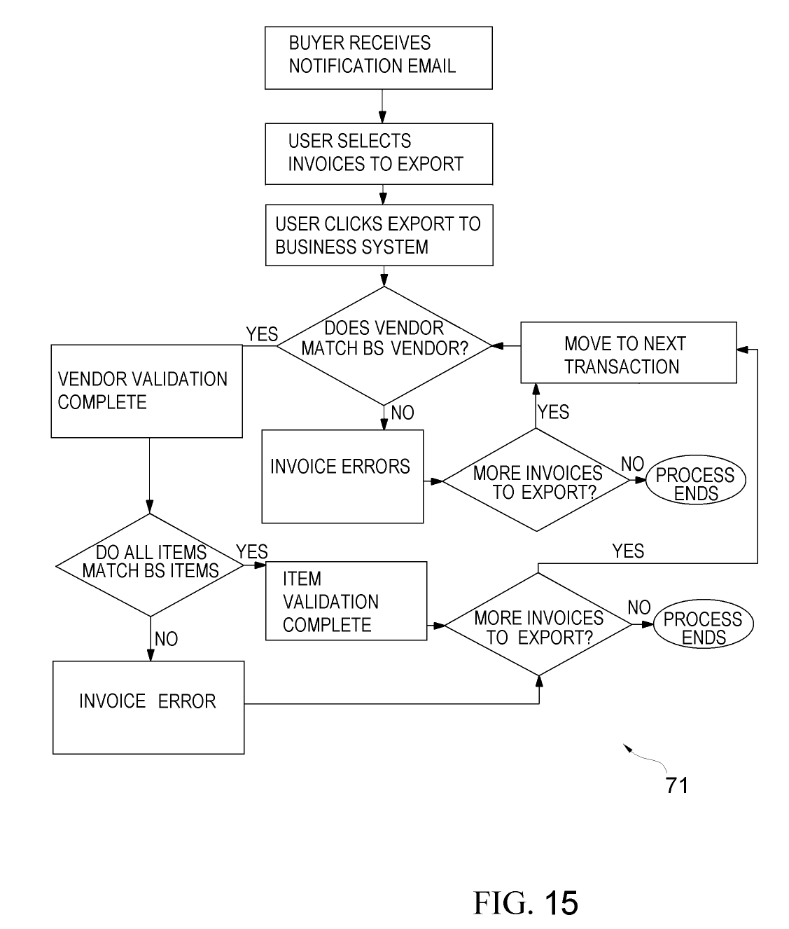

As a representative example of the operation of the order management system of the present invention consider the case of a new system buyer that registers and sends an order to an existing system vendor which is shown in flow chart 67 of FIG. 13. In this scenario, a new system buyer account is created and the user sends its first order 44 off to a vendor 46. The vendor is also a new system user and the vendor 46 registers with system and returns an invoice to the buyer via the system. A seller's process is shown in flowchart 69 of FIG. 14 and a buyer's process is shown in flowchart 71 of FIG. 15.

As will be apparent, there are a variety of document views that will need to exist for users of the order management system. Since a system account can act as both a buyer and a seller all views will need to be available to all users. A user who is a buyer (customer) will have three fundamental views in system; sending orders, viewing the status of sent orders and viewing invoices received.

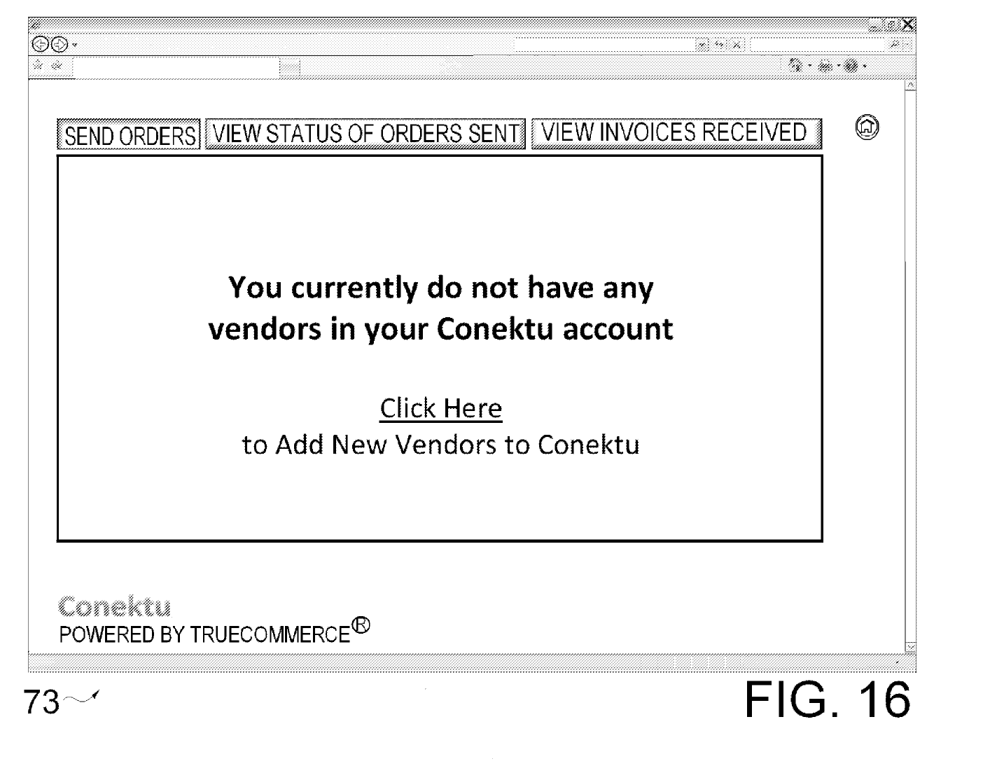

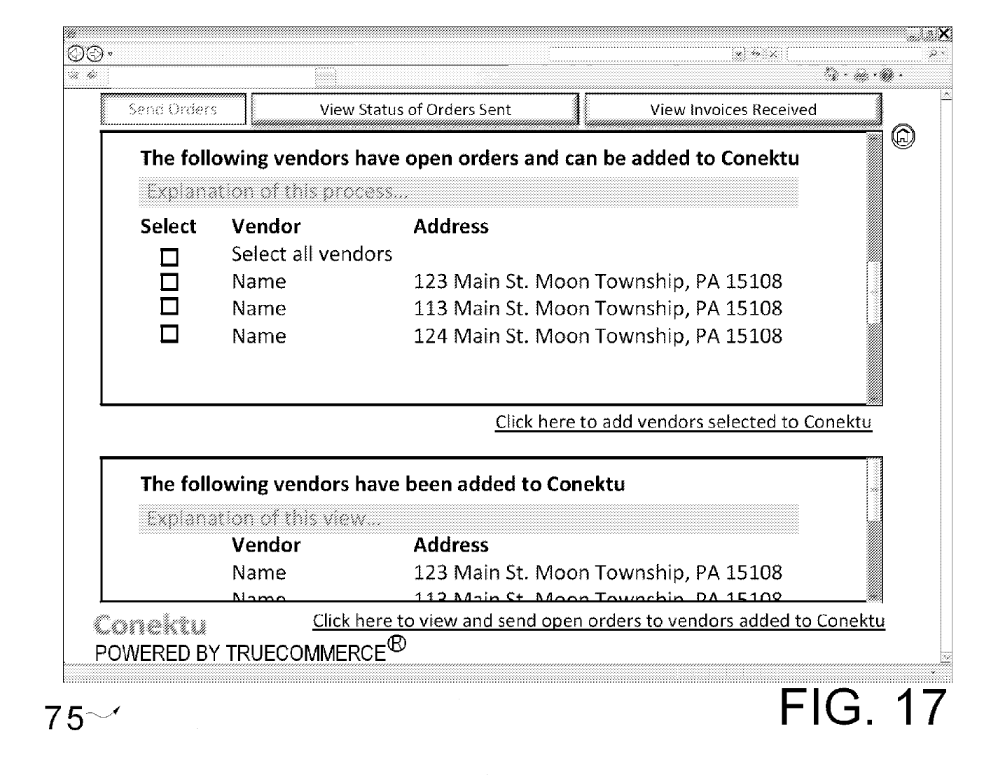

In the “Send Orders” view the user can naturally send orders 44, which consists of extracting orders from the business system 14 as well as initiating the send to the seller. In the “Send Orders” view the user can also add vendors such as shown in screenshot 75 of FIG. 17. This will be the view that a new buyer is brought to after they have completed the configuration wizard. This will continue to be their default view until they have sent at least one order 44. Until they have added a vendor to the system, the only option available will be to add vendors as shown in sample screenshot 73 of FIG. 16. When the user comes to the “Send Orders” view (once they have sent an order), they will be presented with a list of open orders (generated from the business system 14) for all vendors that have been configured for the system.

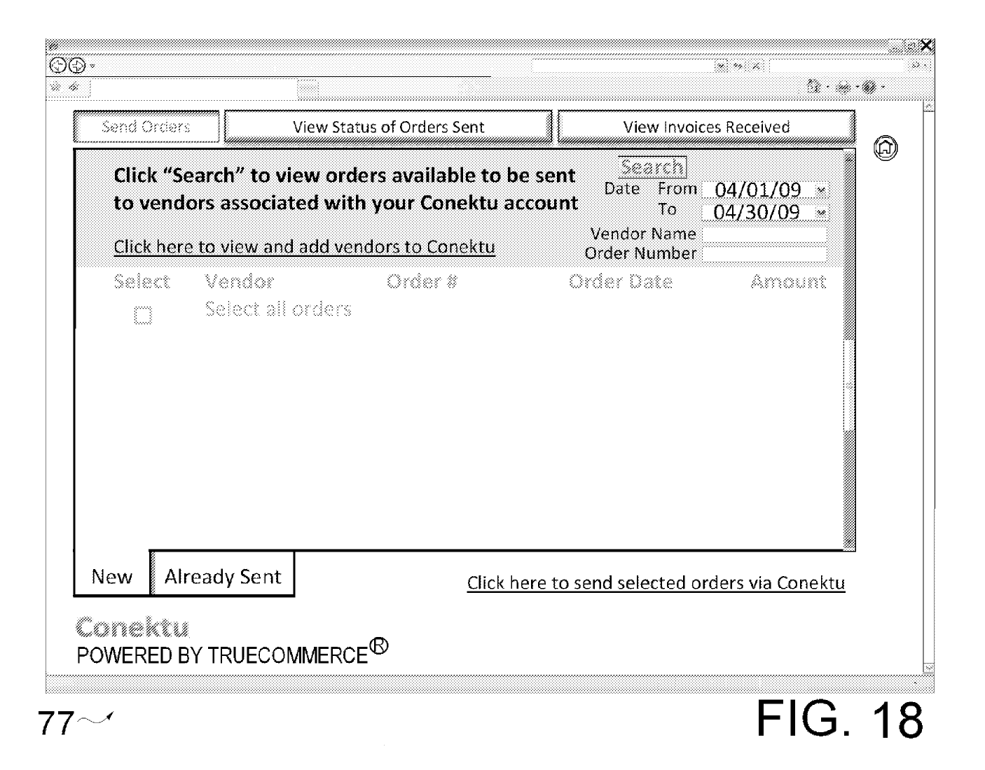

The “Send Orders” view will present the user with a list of orders containing at least the following data; vendor name, order number, order date and order amount. The “Send Orders” view should also provide for a search or filter function for a particular order or group of orders, with the search parameters including: vendor name, order number and date range (for example) as represented in the screenshot 77 of FIG. 18.

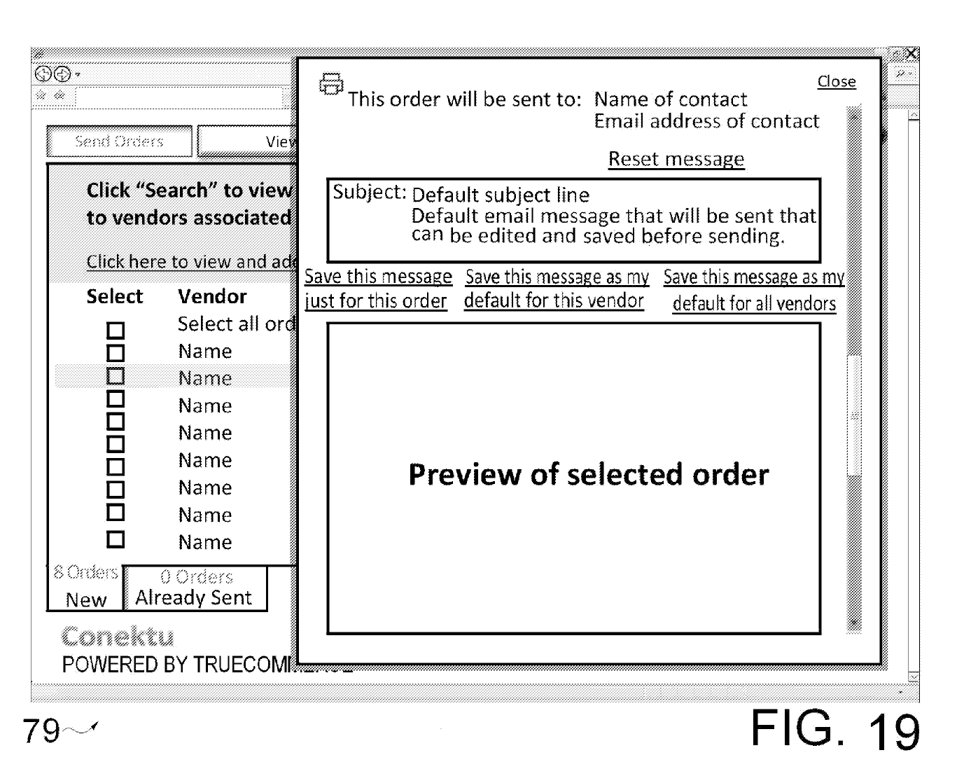

The “Send Orders” view will allow the user to select one or many orders and send, add vendors to the system, view the details of an order by clicking on the order such as shown in screenshot 79 of FIG. 19, and go to the view of orders that they have already sent.

A separate possible view for the buyers can be called “Already Sent” view (not shown in the figures), wherein this view will allow the user to re-import an order from the business system 14 that has already been imported. Sending already sent orders will extract the order from business application 14 again and resend it to the customer or seller. This order would then appear twice in the “View Status of Orders Sent” view as well as the sellers “View Orders Received” view. The “Already Sent” view should provide similar information and functionality as found in the “Send Orders” view.

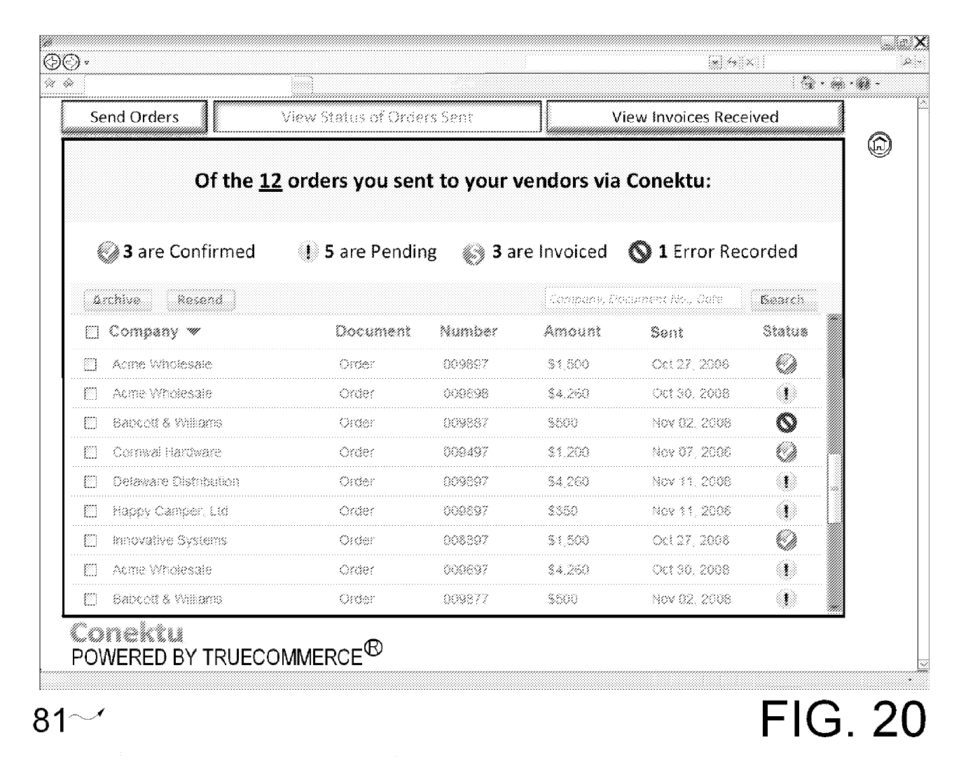

Another view in the present system is the “View Status of Orders Sent” which is represented in screenshot 81 of FIG. 20. This is the default view that will be presented each time a user (buyer) logs into the system once they have sent an order. As noted there are two exceptions to this view being the default, including (a) the first time that the user logs in they will be prompted to complete the configuration wizard and at the conclusion of the wizard they will be presented with the “Send Orders” view, and (b) until such time that they send an order, they will default to “Send Orders” view. If the buyers click on a link from a notification email for an invoice, they will be presented with the invoice for which they received notification.

In the “View Status of Orders Sent” view the buyer will be presented with a list of all orders that they have send to their vendors. This listing will contain the following data: (a) vendor name, (b) order number, (c) amount, (d) send date, (e) flags (if any orders have been flagged—wherein movement of a computer mouse, also called “mousing”, over the flag icon will display the note entered for the flag), and (f) status such as pending, confirmed, error or invoiced.

In the “View Status of Orders Sent” view the buyer will be presented with search or filter functions for a particular order or group of orders, including searching or filtering by vendor name, order number and date range. In the “View Status of Orders Sent” view the buyer will be presented with a summary of the number of documents that are in each status, wherein “mousing” over these will give a brief (i.e. one sentence) description of the status, and clicking on these icons will cause the grid to display only documents in this status.

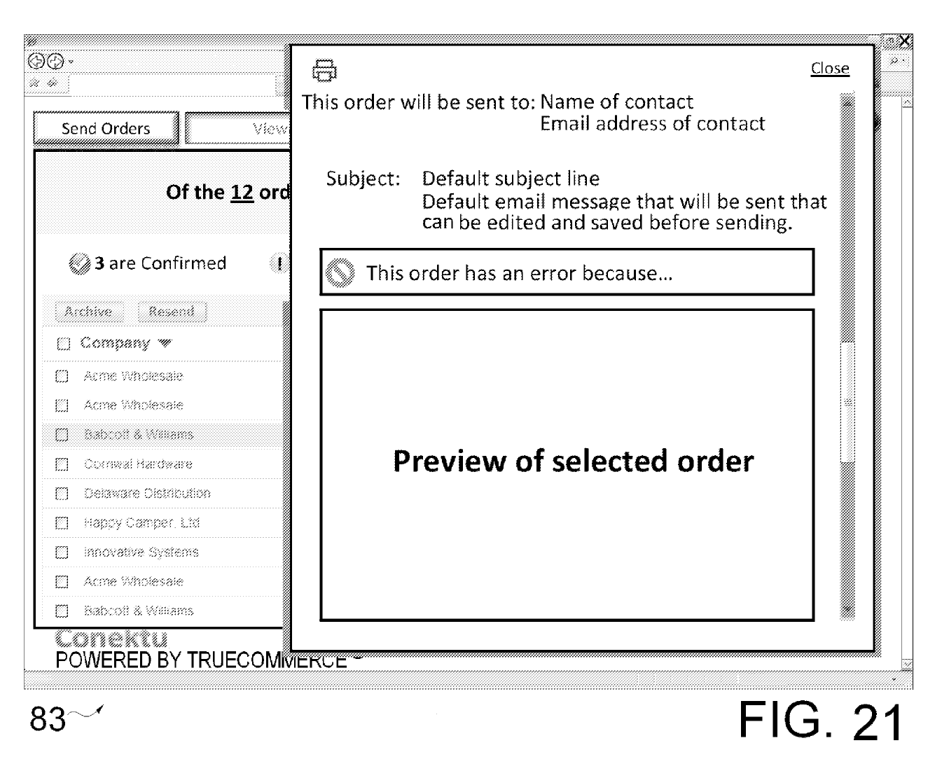

In the “View Status of Orders Sent” view the buyer will have the ability to view an order as schematically represented in screenshot 83 of FIG. 21. The selection of a order will contain order details, status detail such as (a) error information, if any—contains detailed information about the error and what the user can do to resolved it, (b) pending—states that the order is in a pending state until such time that the recipient views it, (c) confirmed—states they date and time that the user viewed the order, or (d) invoiced—specifies the date and time that the invoice was received for this order as well as a link to the invoice. In the “View Status of Orders Sent” view the buyer will have the ability to flag an order, to print one or more orders, to archive one or more orders, and the ability to re-send an order.

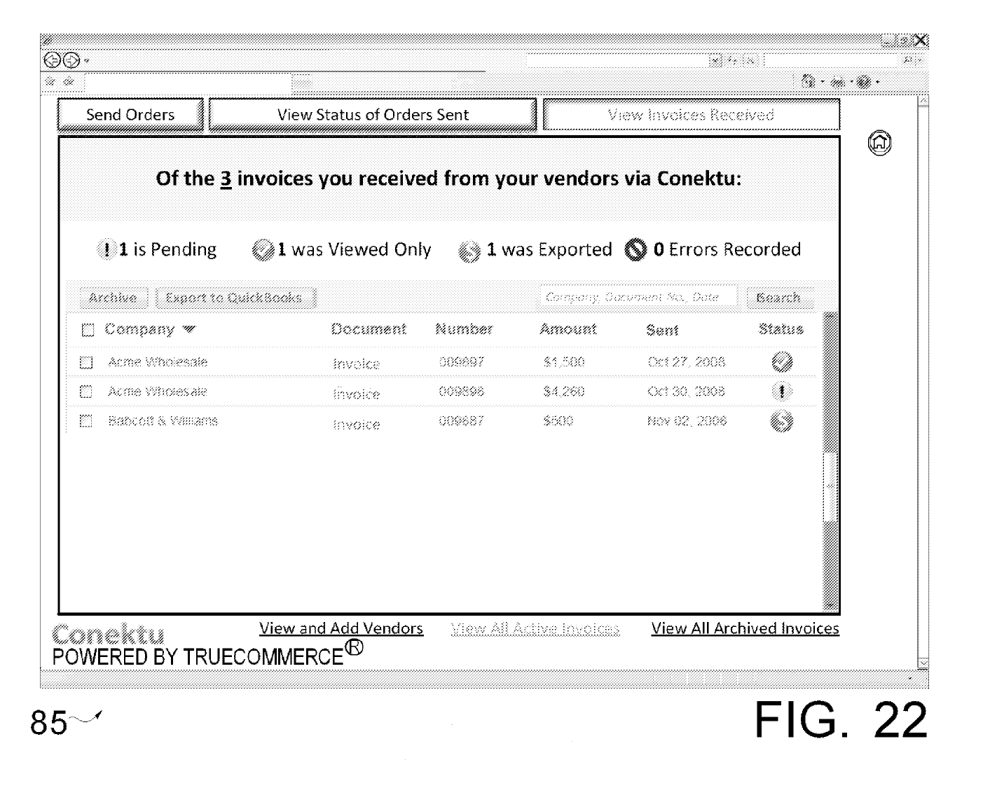

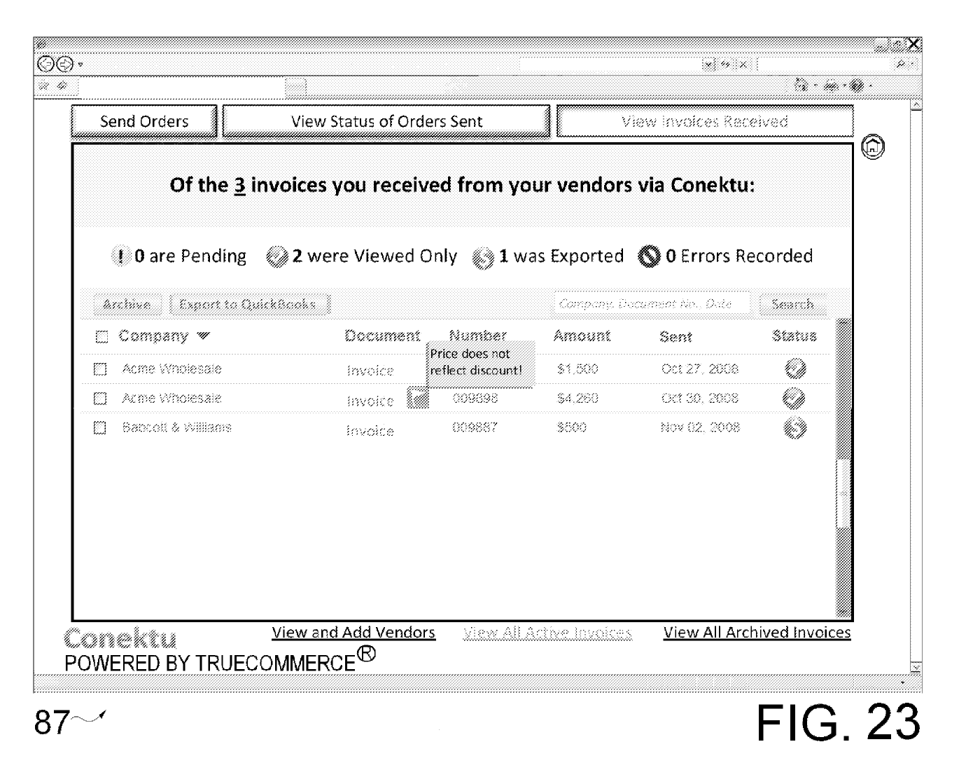

Another view for the buyers in the present system is the “View Invoices Received” which is shown in screenshots 85 and 87 of FIGS. 22 and 23 respectively. From this view there will be a list of all the invoices that they received from their vendors. This listing will contain (a) vendor name, (b) invoice number, (c) amount, (d) received date (e) flags (if any orders have been flagged—wherein mousing over the flag icon will display the note entered for the flag), and (f) status, including pending, confirmed, error, and exported. This view will also contain a search or filter for a particular invoice or group of invoices with appropriate searching or filtering parameters such as vendor name, invoice number and date range. This view will provide a summary of the number of documents that are in each status wherein mousing over these will give a brief description of the status and clicking on these will cause the grid to display only documents in this status. This view will provide the ability to view a selected invoice, including Invoice details, and Status detail (such as error—contains detailed information about the error and what the user can do to resolved it, confirmed—states they date and time that they viewed the invoice, and exported—specifies the date and time that the invoice was exported to the business system). If an invoice is in a pending status, it will automatically change to confirmed when the user opens it. This view will provide the ability to flag one or more invoices, to print one or more invoices, and the ability to export one or more invoice, and the ability to archive one or many invoices.

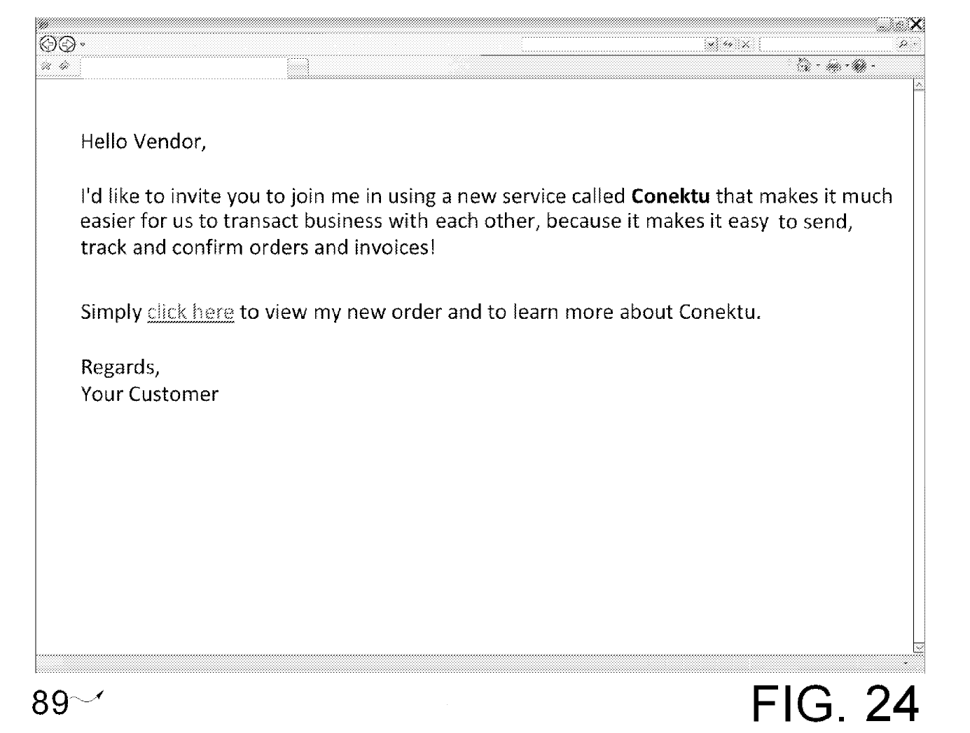

The registered sellers 42 or 46 have a number of views in the system. Non-registered sellers 48 do not, although it is expected that such sellers would receive an invitation to join the system such as represented in screenshot 89 of FIG. 24. Should sellers remain unregistered, they will receive orders from buyers in the system via e-mail with link (or other designated manner) which would be expected to duplicate their current business process. As noted above the system is designed for substantially frictionless adoption by new vendors to drive the expansion of the system. The more sellers that are on the system the more invoices can be pushed directly into the buyer's business application or business system 14.

The registered sellers 42 or 46 are provided with a “View Orders Received” view which is the default view that will be presented each time a user (seller) logs into the system. From this view they will be presented with a list of all orders that they received from their customers. This listing will contain customer name, order number, amount, received date, flags (if any orders have been flagged—wherein mousing over the flag icon will display the note entered for the flag, and status such as pending, confirmed, and converted to invoice. This view will also allow for search or filter for a particular invoice or group of invoices, with the anticipated search parameters including customer name, order number and date range. This view will contain a summary of the number of documents that are in each status, wherein mousing over these will give a brief description of the status, and clicking on these will cause the grid to display only documents in this status. This view will provide the ability to view an order, including order details, status detail (such as confirmed—states they date and time that they viewed the order—however if an order is in a pending status, it will automatically change to confirmed when the user opens it, and converted to invoice—specifies the date and time that the invoice was created for the order as well as then the invoice was sent to the customer, however if the invoice has not yet been sent, the information will not be available). The view will provide the ability to convert order or orders to invoice, the ability to archive an order or orders, and the ability to print an order or orders.

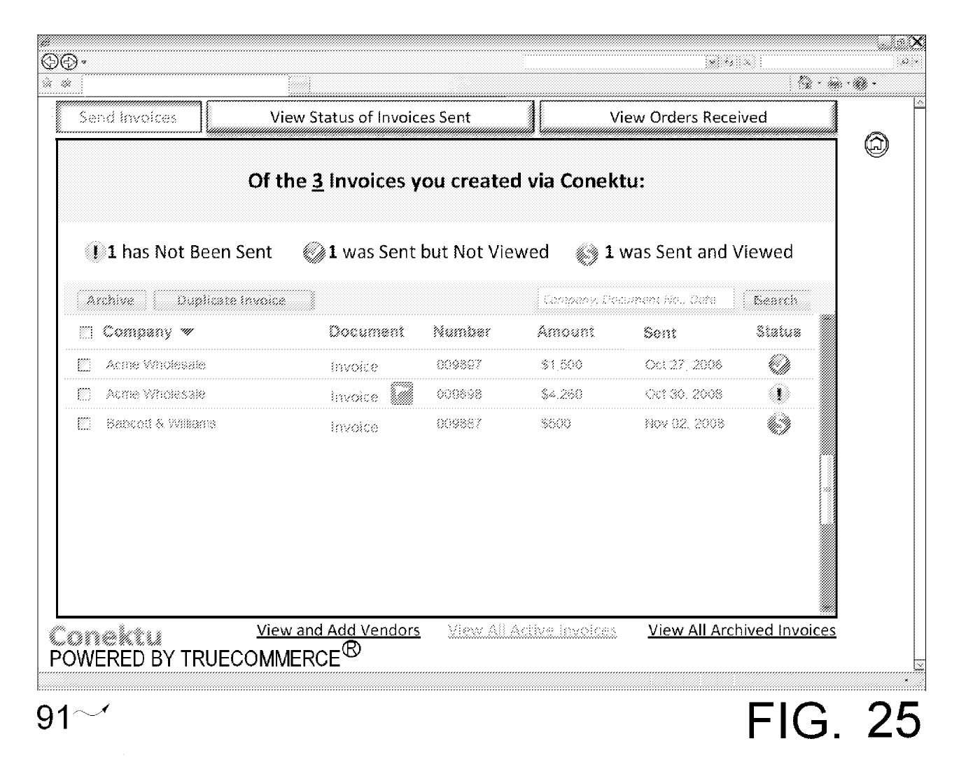

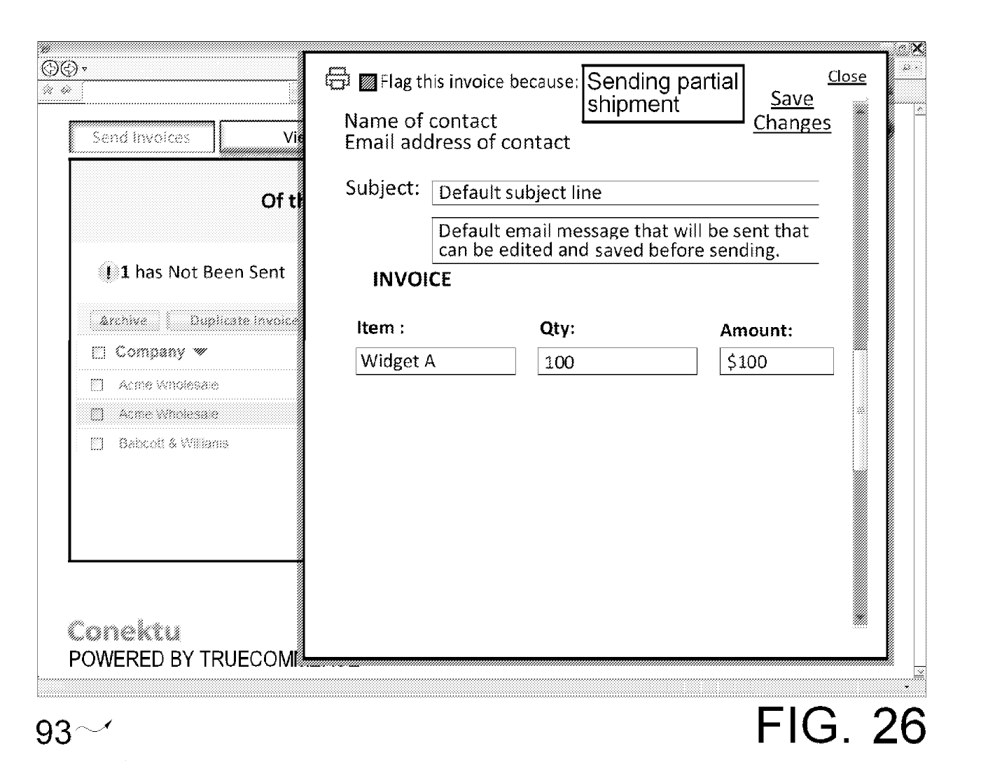

The registered sellers 42 or 46 are provided with a “View Status of Invoices Sent” view shown in screenshots 91 and 93 of FIGS. 25 and 26 respectively, and which will list of all invoices that they have sent to their vendors. This listing will contain the customer name, invoice number, amount, send date, flags (if any orders have been flagged—wherein mousing over the flag icon will display the note entered for the flag) and status such as pending, confirmed or error. This view will provide the ability for search or filter application for a particular order or group of orders with the search parameters including customer name, invoice number and date range. This view includes a summary of the number of documents that are in each status, wherein mousing over these will give a brief description of the status and clicking on these will cause the grid to display only documents in this status.

The “View Status of Invoices Sent” view gives the ability to view a selected invoice, as shown in FIG. 26 and the view would include the Invoice details, the Status detail (which here is error—contains detailed information about the error and what the user can do to resolve it, pending—states that the invoice is in a pending state until such time that the recipient views it, and confirmed—states the date and time that the user viewed the order). This view includes the ability to flag the invoice and to print the invoice. This view includes the ability to archive one or many invoices and the ability to resend one or many invoices.

The registered sellers will have a “Send Invoices” that will list invoices that the seller has created via turnaround or the “convert to invoice” function. If no invoices have been created, and not send this view would not contain any documents. This view will allow the user to select and send invoices, and to list of invoices that have not yet been sent. The listing of unsent invoices includes the customer name, invoice number, invoice date and invoice amount. This view will provide a search or filter for a particular invoice or group of invoices with the suggested search parameters including customer name, invoice number and date range. This view will provide the user with the ability to view and update the invoice, wherein the details of the invoice can be edited. The seller will be provided with the ability to flag a selected invoice, to print a selected invoice and to delete a selected invoice.

As noted above, in most views of either the buyer or seller, the registered users will have the ability to “flag” documents. This is a way for them to track their own notes about a particular document. Notes are only internal (i.e. the seller cannot see the buyers notes and vice versa). Users are able to flag documents for whatever purpose they would like. When a user flags a document, they can add a note to the document. When looking at any of the document list views, flagged documents will have some type of icon or graphic to make them stand out and Mousing over the icon of a flagged document allows the user to see the note that is associated.

An “Account Settings” view will allow for users to update their settings. The user should be able to navigate to this section from anywhere on the on-line website. From here, any user can maintain or manage the company information (e.g., company name, company address (including city, state, zip country), contact information and phone, etc). Additionally the user can update information regarding the business system 14, particular listing (insert details), or the user profile (e.g. name, title, email, password, security question or security answer). The user can adjust vendor information. The system may prompt for clarification of conflicts in vendor information. The user may also update list of the customer that they have received orders from via the system or designated customer information.

As described above the system allows for member to customize the documents such as adding their own logo to orders and invoices that they send. This logo will be visible via the view in system and will print if the sender or receiver prints the document. The users will have the ability to add this logo as part of the configuration wizard. The logo can also be added or maintained in the account settings section. A preview option will be available to allow the user to see what the logo will look like on the order or invoice.

The system provides for a variety of notifications, wherein the system will email notifications for various events. These include when a new document was received wherein the document notifications will be sent to all registered users of the account that is the receiver. There will be four different new document notifications.

The first type of new document notification is to a buyer that they have received an invoice from a seller. This notification will identify the sender or the invoice and will contain a link to view the invoice in system. This link will bring them directly to the invoice that they want to view. Further this notification will contain any message content provided by the sender.

The second type of new document notification is to a non-registered seller that they have received an order which identifies the sender of the order, contains the invoice via a link (or other method), contains any message content provided by the sender, contains messaging about registering with the system and the associated benefits, and contains a link to register with the system.

The third type of new document notification is to a registered seller that they have received an order and this identifies the sender of the order, and contains a link to view the invoice in they system. This link will bring them directly to the order that they want to view. If they are not logged into the system, they will first be presented with the login screen to enter their credentials and then will be taken to the order. If they are already logged in, the link will take them directly to the order. Further this notification contains any message content provided by the sender.

The fourth type of new document notification is a notification to the buyer that a seller has opened an order. The system will not permit the seller from bypassing this notification.

As discussed above users can invite new users to be members of their account. This process is detailed out in the user management discussion above. These emails will contain the name of person that invited them, a personal message (if invitee enters one), a username (email address), a temporary password, an email confirmation link, and a link to the system home page.

The order management system is not intended for non-registered buyers, as noted above it typically is a buyer's side solution. However the present system could accommodate such non-registered buyers for a registered seller 46 (or registered buyer/seller 42), where the purchase order 44 is generated using the sellers business application 14. This would require the seller giving the non-registered buyer a forum, e.g. a website or dedicated connection, for generating a “seller's side purchase order.” However it would then allow the seller to receive such orders from non-registered buyers and still have the order management offered by the present system. The seller's side component described here is somewhat similar to other existing order management solutions that allow for tracking orders and invoices on the seller side. This is intended only to show the present invention is not restrictive and is adaptable to a variety of implementations. It would be preferred if the buyer becomes a registered buyer in the present system, but this addition is presented as an alternative, such as where the buyer has no supported business application 14.

It will be apparent to those of ordinary skill in the art that various modifications may be made to the present invention without departing from the spirit and scope thereof. The scope of the invention is not to be limited by the illustrative examples described above.

What is claimed is:

1. A user-deployable data transformation and exchange platform including (a) an on-demand item synchronization formed by a user buildable dynamic link library associating incongruent article identifiers used by the user and at least one other party to reference a common article to be purchased or sold between the user and the party; and (b) a user deployable order management system for generating, sending, receiving, and tracking the status within defined workflows of documents necessary to facilitate the procurement of goods and services between the user and at least one other party.

2. The user-deployable data transformation and exchange platform according claim 1 wherein the platform includes data normalization software, data conversion software and data mapping software.

3. The user-deployable data transformation and exchange platform according claim 2 wherein the platform further includes a common network exchange coupling the user with each other party.

4. The user-deployable data transformation and exchange platform according claim 3 wherein the data normalization software, data conversion software and data mapping software and the common network exchange are provided on-line.

5. The user-deployable data transformation and exchange platform according claim 1 wherein searchable transaction histories are maintained for member users, with each transaction having a current status identified and the ability to be flagged by a member user within the system.

6. The user-deployable data transformation and exchange platform according claim 1 including automated, member user originated, participant invitation for registration of new members.

7. The user-deployable data transformation and exchange platform according claim 6 wherein the automated member user originated participant invitation includes electronic notification to a prospective member.

8. The user-deployable data transformation and exchange platform according claim 7 wherein the registration of new members utilizes at least some data associated with the new member that was generated by the member generating the participant invitation.

9. The user-deployable data transformation and exchange platform according claim 7 wherein searchable transaction histories are maintained for member users, with each transaction having a current status identified and the ability to be flagged by a member user within the system.

10. A user deployable order management system for generating, sending, receiving, and tracking the status within defined workflows of documents necessary to facilitate the procurement of goods and services between a member user and at least one other member or non-member party, and including automated, member user originated, participant invitation for registration of new members.

11. The user deployable order management system according to claim 10 wherein the automated member user originated participant invitation includes e-mail notification to a prospective member.

12. The user deployable order management system according to claim 12 wherein the registration of new members utilizes at least some data associated with the new member that was generated by the member generating the participant invitation

13. The user deployable order management system according to claim 10 wherein the order management system is a buyer side management system.

14. The user deployable order management system according to claim 10 wherein the documents tracked include at least purchase orders and invoices.

15. The user deployable order management system according to claim 10 wherein searchable transaction histories are maintained for member users, with each transaction having a current status identified and the ability to be flagged by a member user within the system.

16. A user-deployable data transformation and exchange platform for transferring data among members of the platform, the platform including an on-demand item synchronization formed by a user buildable dynamic link library associating incongruent article identifiers used by the user and at least one other member to reference a common article associated with the two members.

17. The user-deployable data transformation and exchange platform according claim 16 wherein the platform includes data normalization software, data conversion software and data mapping software.

18. The user-deployable data transformation and exchange platform according claim 17 wherein the platform further includes a common network exchange coupling the members.

19. The user-deployable data transformation and exchange platform according claim 18 wherein the data normalization software, data conversion software and data mapping software and the common network exchange are provided on-line.

20. The user-deployable data transformation and exchange platform according claim 19 including and order management system.
